(19) United States
(12) Patent Application Publication
(10) Pub. No.: US 2012/0056041 A1
(43) Pub. Date: Mar. 8, 2012

(54) Unmanned Flying Vehicle Made With PCB

(75) Inventors: Sung Ho Rhee, Daejeon (KR); Yong Seung Lee, Daejeon (KR)

(73) Assignee: DREAM SPACE WORLD CORPORATION, Daejeon (KR)

(21) Appl. No.: 12/954,975

(22) Filed: Nov. 29, 2010

(30) Foreign Application Priority Data
Sep. 2, 2010 (KR) 10-2010-0086052

(51) Int. Cl. G05D 1/00; B64C 25/32; B64C 25/02; B64C 1/00; B64C 39/00

(52) U.S. Cl. 244/4 R

(57) ABSTRACT

The present invention relates to an unmanned flying vehicle using a PCB including a main board controlling power supply and flying operation, a motor rotating a propeller by changing electric energy into mechanical energy, a PCB frame changing a signal from a remote controller and connecting the main board with the motor, a propeller generating an impellent force by from rotation by the motor, a receiver receiving a control signal of the remote controller, and a remote controller controlling a motor rotation speed of a quadrotor and direction change, and accordingly, the structure of the unmanned flying vehicle can be simplified so that the flying vehicle can be down-sized and light-weighted, and assemblability can be improved.

### CROSS-REFERENCE TO RELATED APPLICATION

This application claims priority to and the benefit of Korean Patent Application No. 10-2010-0086052 filed in the Korean Intellectual Property Office on Sep. 2, 2010, the entire contents of which are incorporated herein by reference.

### BACKGROUND OF THE INVENTION

(a) Field of the Invention

Exemplary embodiments of the present invention relate to an unmanned flying vehicle that can reduce its size or weight and production cost by realizing a structure of the vehicle using a PCB for electronic parts installation.

(b) Description of the Related Art

Recently, the need of an unmanned flying vehicle in an environment where a person feels difficult to work has been increased. The need of an unmanned flying vehicle in an environment where The unmanned flying vehicle has been applied to wide areas, for example, the flying vehicle can acquire video images in an unapproachable disaster area in the air, test power lines, or provide concealed information of the enemy in a battlefield, or it can perform a reconnaissance flight or a surveillance flight.

A conventional unmanned flying vehicle has a structure of which a body and wings are formed with a simple composite material or wood so that the body and the wings are independently realized from electric and electron structures that control an electronic device for a flight. Such a structure of the unmanned flying vehicle increases the weight of the flying vehicle such that a flight efficiency is decreased, and the weight increase causes the main board, the battery, and the propeller to be enlarged, and accordingly the structure of the flying vehicle is complicated, difficult to be assembled, and production cost of the flying vehicle can be increased.

FIG. 1 illustrates a structure of a conventional unmanned flying vehicle.

The unmanned flying vehicle of FIG. 1 includes a main board 10 controlling power supply and flying operation, a motor 20 rotating a propeller by changing electric energy to mechanical energy, a transmission 30 that changes a signal from a remote controller into a signal for motor control, a propeller 40 rotating by the motor 40 and generating an impellent force through the rotation, a frame 50 connecting the main board 10 at the center of the vehicle with an external motor and supporting the same, a receiver 60 receiving a control signal from the remoter controller, and a battery 70.

The unmanned flying vehicle of FIG. 1 performs flying operation with an impellent force acquired by providing four motors 20 respectively connected to the frame 40 in four directions with reference to the main board 10, the receiver 60, and the battery 70 and rotating the propeller 40 by mounting the propeller 40 on the motor 20.

The unmanned flying vehicle of FIG. 1 has unlimited applicable ranges, but all electron modules are collected in the main board 10 at the center thereof so that the size of the main board 10 is increased and circuit configuration is complicated. Thus, the unmanned flying vehicle is entirely increased in size and weight so that excessive amount of power is used for driving of the vehicle, and the type of motor that can be used is limited because more than a predetermined amount of power is required. In addition, such limitations cause increase of production cost of the unmanned flying vehicle. Further, the amount of heat generated from the main board 10 is increased due to the complicated circuit configuration, thereby causing frequent troubles and malfunctions.

Meanwhile, since the transmission 30 is typically disposed on the frame 50 as shown in FIG. 5, the main board 10 and the transmission 30 should be connected through a wired cable for control of the transmission 30, and this causes the weight of the flying vehicle to be increased and the structure thereof to be complicated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an unmanned flying vehicle that can be down-sized and light-weighted by simplifying the structure, and having improved assemblability.

According to an exemplary embodiment of the present invention, a method for preventing torsion of the flying vehicle and enabling stable landing of the unmanned flying vehicle by absorbing external impact at landing is provided.

According to another exemplary embodiment of the present invention, a method for guaranteeing safety during a flight of the flying vehicle is provided.

Thus, an unmanned flying vehicle according to the present invention includes a body portion formed at a center thereof; a plurality of frame portions having one end connected to the body portion and forming the entire shape of the unmanned flying vehicle; and a plurality of driving portions mounted on the other end of the frame portion and generating an impellent force for a flight, and the frame portion is formed of a print circuit board.

The body portion may include a main board in the shape of PCB where at least one of a control module for flying control and a communication module for exchanging data with an external communication device is installed, and the body portion may further include a battery for supplying power to the main body, the frame portion, and the driving portion.

In addition, the body portion may include a plurality of main boards, the plurality of main boards are supported by a plurality of supporting shafts with a predetermined distance therebetween, and the battery may be disposed in a portion of the predetermined distance.

The frame portion may further include a landing means to support the flying vehicle for landing of the flying vehicle with a predetermined height from the ground.

Further, the frame portion may further include a support means mounted on the bottom side of the frame portion to prevent bending and torsion of the frame portion of the unmanned flying vehicle due to the weight of the driving portion of the flying vehicle.

At least one of the body portion and the frame portion may be formed of a FR4 PCB.

According to the exemplary embodiments of the present invention, the structure of the unmanned flying vehicle can be simplified and the entire size can be minimized by installing constituent modules installed in the main board of the body portion and diversely installing other modules in the frame portion.

In addition, the frame portion is formed with a PCB so that wired cables between the constituent modules in the main board and the modules diversely formed in the frame portion can be eliminated, thereby simplifying the structure of the unmanned flying vehicle.

Further, as the frame portion is formed with a PCB, the frame portion is light-weighted so that it can fly with a small impellent force and accordingly various types of motors can be applied to the flying vehicle, and relatively inexpensive motor and propeller can be used so that production cost of the unmanned flying vehicle can be reduced. Particularly, the unit cost of parts can be reduced by integrally realizing the frame and the transmission in the PCB, and accordingly the production cost can be further reduced compared to a case that the frame and the transmission are separately realized.

In addition, as the frame portion is light-weighted, the total weight of the unmanned flying vehicle is reduced so that auxiliary devices such as a camera and lighting can be additionally amounted to the flying vehicle, and accordingly the unmanned flying vehicle can be applied to various fields replacing a person.

### BRIEF DESCRIPTION OF THE DRAWINGS

FIG. 1 shows a structure of an unmanned flying vehicle according to a conventional art.

FIG. 2 shows a structure of an unmanned flying vehicle according to an exemplary embodiment of the present invention.

FIG. 3 shows a structure of an unmanned flying vehicle according to another exemplary embodiment of the present invention.

FIG. 4 shows an exemplary structure of an unmanned flying vehicle additionally including a landing means.

FIG. 5 shows another exemplary structure of an unmanned flying vehicle additionally including a landing means.

FIG. 6 shows an exemplary structure of an unnamed flying vehicle additionally including a supporting means.

FIG. 7 and FIG. 8 show other exemplary structures of supporting means.

FIG. 9 shows an exemplary structure of an unmanned flying vehicle additionally including a propeller safety cover.

FIG. 10 shows another exemplary structure of an unmanned structure of an unmanned flying vehicle additionally including a propeller safety cover.

### DETAILED DESCRIPTION OF THE EMBODIMENTS

The present invention will be described more fully hereinafter with reference to the accompanying drawings, in which exemplary embodiments of the invention are shown.

In the specification, “unmanned flying vehicle” refers to a flying vehicle that can be remotely controlled by a person without boarding thereon, and in further detail, it includes a trirotor having three propellers, a quadrotor having four propellers, a pentarotor having five propellers, a hexarotor having six propellers, and an octorotor having eight propellers. Thus, the quadrotor will be exemplarily described for convenience of description, but the present invention is not limited thereto, and it may be variously modified according to the number and configuration of the propellers.

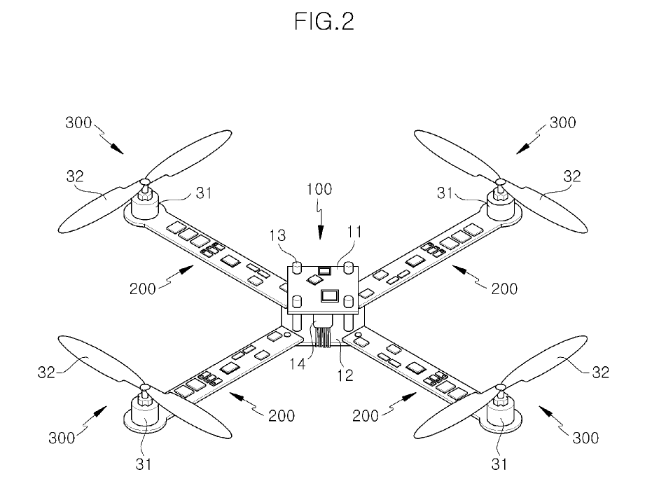

FIG. 2 illustrates a structure of an unmanned flying vehicle according to an exemplary embodiment of the present invention.

The unmanned flying vehicle shown in FIG. 2 includes a body portion 100, four frame portions 200, and four driving portions 300, and the driving portions 300 are respectively mounted at one ends of the respective frame portions 200 and the other ends of the respective frame portions 200 are coupled to the body portion 100 in the center of the vehicle.

The frame portions 200 and the body portion 100 may be coupled using a bolt and a nut, and any fastening means can be used to fix and connect the two constituents 100 and 200. In addition, the frame portion 200 and the body portion 100 may also be connected to each other through a predetermined node in addition to the physical connection using the fastening means so as to transmit power and a control signal to each module mounted on each of the frame portions 200.

FIG. 2 illustrates that the four frame portions 200 of the unmanned flying vehicle are formed in the shape of “|”, but the present invention is not limited thereto. An unmanned flying vehicle may be formed with two frame portions that are formed in the shape of “ [symbol] ”. In the latter case, the frame portions in the shape of “ [symbol] ” are mounted to the body portion 100 such that it becomes symmetric to each other with reference to a vertex of each frame portion.

Configuration of Body Portion 100

The body portion 100 according to the present exemplary embodiment may be formed with a main board for installing at least one of a main control module (not shown) for controlling flying operation of the flying vehicle, a communication module (not shown) for receiving a control signal from a remote controller or exchanging data with a remote control station, a sensor module (not shown) collecting at least one of location data/image data/temperature data/wind data/roughness data therein and a battery supplying power to the driving portions 300.

The shape of the body portion 100 may be changed according to the type of the flying vehicle. That is, in the case of a trirotor, the body portion 100 may be formed in the shape of a regular triangle plate, and in the case of a quadrotor, it may be formed in the shape of a regular square plate. However, the shape of the body portion 100 is not limited thereto, and it may be formed in the shape of a circular plate in the case of a common rotor.

FIG. 2 exemplarily illustrates that the main board of the body portion 100 includes a first main board 11 and a second main board 12, and the first main board 11 and the second main board 12 are supported by four supporting shafts 13 and a battery 14 is disposed in a space between the first and second main boards 11 and 12.

Here, all of the main control module, the communication module, and the sensor module may be disposed in one of the first and second main boards 11 and 12, or may be separately disposed in the two boards 11 and 12. In addition, FIG. 2 shows an exemplary realization of the body portion 100, and thus the main boards 11 and 12 and the battery 14 forming the body portion 100 may be variously modified by a person skilled in the art.

A body portion 100 according to another exemplary embodiment may be formed with a main board that installs at least one of the main control module, the communication module, and the sensor module therein. In this case, a battery 200 may be included in a frame portion 200.

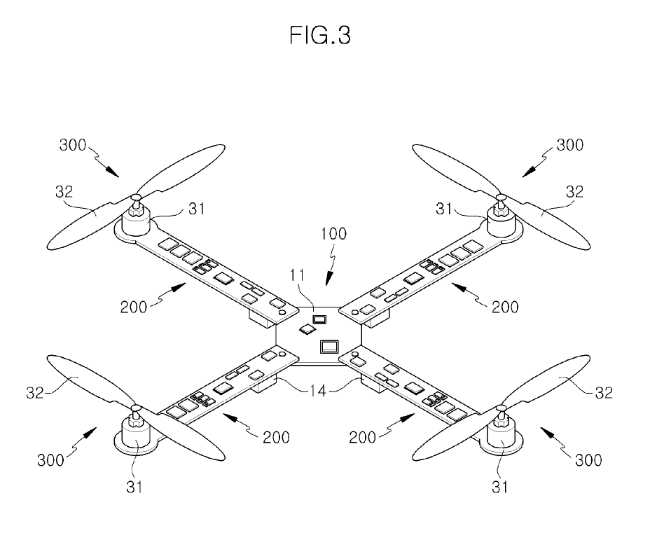

FIG. 3 shows a structure of an unmanned flying vehicle according to another exemplary embodiment of the present invention.

As show in FIG. 3, a body portion 100 is formed with a single main board 11, and a battery 14 is mounted on a bottom side of a frame portion 200 to function as a landing means (or, a landing gear) of the unmanned flying vehicle as well. In this case, the battery 14 is preferably disposed close to the main board from the bottom side of the frame portion 200 in order to design the center of gravity of the vehicle to be close to the center portion thereof.

Configuration of Frame Portion 200

The frame portion 200 is realized as a printed circuit board (PCB) that installs other modules (e.g., a transmission) than the control modules, the communication modules, and the sensor modules among various modules required for operation of the unmanned flying vehicle.

As shown in FIG. 2, the frame portion 200 may be realized as a PCB formed in the shape of “|” (or, a long rectangle), and preferably one end thereof where the driving portion 300 is mounted may be formed in the shape of a circle so as to distinguish it from the other end fixed to the body portion 100.

The frame portion 200 may be formed with a balsa tree, woodlac (or, expanded poly-styrene), carbon, aluminum, or a polyvinyl chloride (PVC) material, or may be formed with a PCB made of a frame retardant-4 (FR4) material (hereinafter, referred to as a FR4 PCB).

The balsa tree and the woodlac have merits that they are light-weighted and absorb vibration, and carbon has a merit of excellent durability and flexibility. In addition, aluminum has excellent durability and impact resistivity.

The FR4 PCB is formed of a compound material of glass and epoxy so that it has excellent flexibility and durability and is applicable to a single-sided or double-sided PCB, and is inexpensive. In addition, thermal resistance is decreased by reducing the thickness of an insulating adhesive layer so that thermal conductivity is increased, and insulation and heat radiation effects are increased by dual special coating of the metal layer.

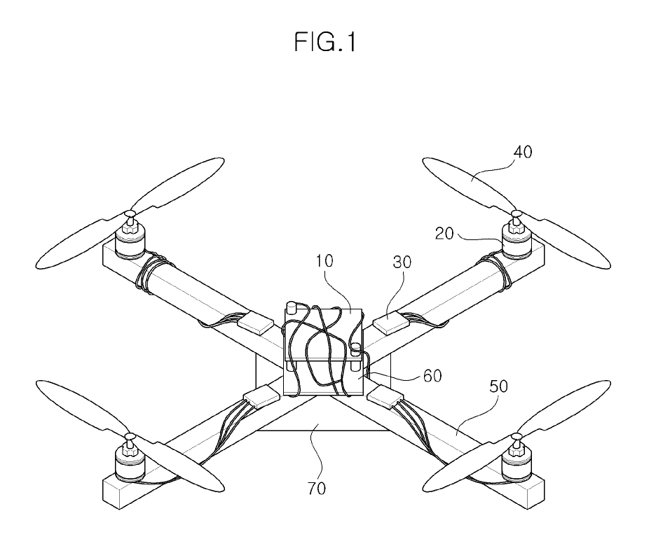

When the frame portion 200 is made of FR4 PCB and the transmission 30 of FIG. 1 and the frame 50 of FIG. 1, which has been individually realized in the conventional unmanned flying vehicle, are integrally formed in the frame portion 200, the following weight comparison between the unmanned flying vehicle and the conventional unmanned flying vehicle can be acquired.

In an example of an experimental condition, the frame portion 200 of the unmanned flying vehicle is formed of dual FR4 PCB having a thickness of less than 2 mm, but the transmission and the frame portion are integrally formed. In this case, it can be observed through the Table 1 that a total weight of the transmission and the frame is about 50% reduced compared to the conventional unmanned flying vehicle by reducing the weight from 56 g to 28 g.

TABLE 1

| | Transmission (g) | Frame(g) |
|---|---|---|
| Conventional quad rotor | 4(ea) * 4(g) = 16(g) | 4(ea) * 10(g) = 40(g) |

| | |
|---|---|
| FR4 PCB-applied | 4(ea) * 7(g) = 28(g) |
| quadrotor | |

The frame portion 200 may further include a landing means 21 for maintaining stable position and easing landing impact when the unmanned flying vehicle is landed on the ground. That is, the frame portion 200 is realized as a PCB so that it has a thin thickness and excellent flexibility. As a result, the following useful characteristics may be acquired.

That is, compared to the frame 50 of FIG. 1, the frame portion 200 made of a PCB material is not broken when impact is applied thereto due to its flexibility, and the frame portion 200 absorbs vibration of a motor, generated from rotation of a propeller so that an error of the sensor can be minimized by reducing the vibration transmitted to the main board. In addition, when a camera is mounted on the unmanned flying vehicle, vibration from the motor is reduced while passing through the frame portion 200 and thus the vibration transmitted to the camera is minimized, thereby acquiring images and photos with high resolution.

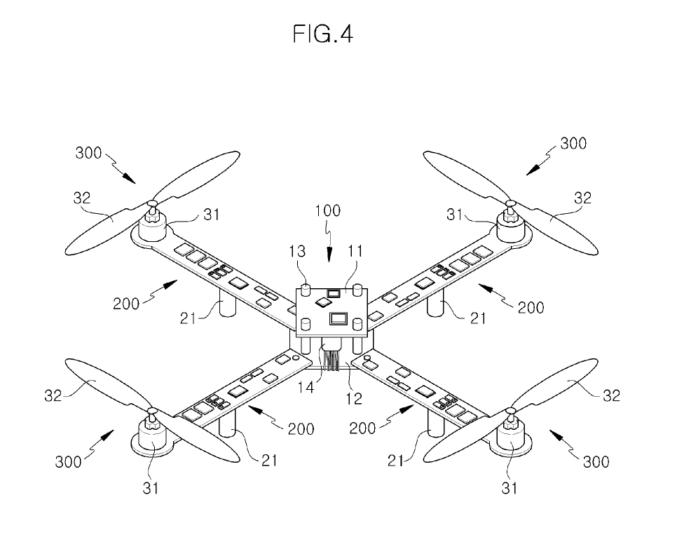

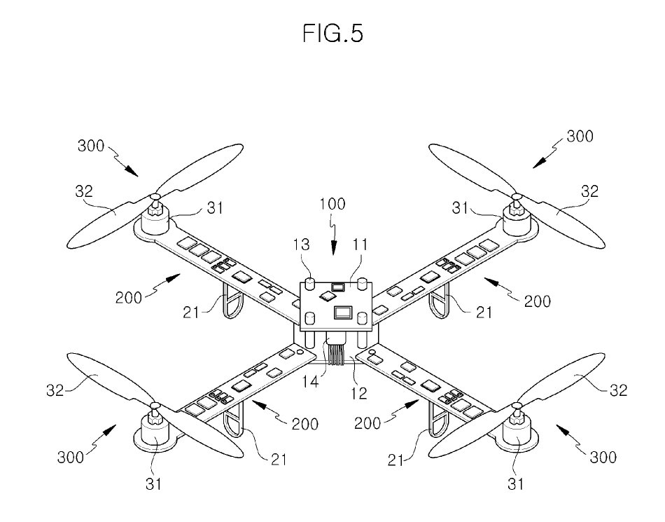

FIG. 4 and FIG. 5 respectively show exemplary embodiments of the unmanned flying vehicle further having a landing means.

As shown in FIG. 4, the landing means 21 may be realized in the shape of a vertical cylinder. In this case, the cylindrical landing means 21 is mounted on a bottom side of the frame portion 200, and is preferably mounted on a center portion in a length direction of the frame portion 200 so as to effectively break up the weight of the unmanned flying vehicle.

In addition, as shown in FIG. 5, the landing means 21 may be realized as a frame in the shape of “U” with a support formed in a center thereof. However, the present exemplary embodiment is not limited thereto, and the landing means may be realized as a plate in the shape of “U”. The landing means 21 of FIG. 5 is mounted on a bottom side of the frame portion 200, and is preferably mounted on a center portion in a length direction of the frame portion 200 so as to effectively break up the weight of the unmanned flying vehicle.

Although it is not shown in FIG. 4 and FIG. 5, the landing means 21 may be realized with various shapes. That is, the landing means 21 may be realized in the shape of “ [symbol] ” not only to further increase an area contacting the ground than the cylindrical landing means 21 of FIG. 4 for supporting the frame portion 200 but also to function as a landing gear for smooth landing by absorbing external impact when the unmanned flying vehicle is landing.

In addition, the landing means 21 may be made of poly-styrene, a memory form, or a hardened sponge to simultaneously satisfy supportability and impact absorbability and these materials are suitable for the landing means 21 of FIG. 4. The landing means 21 of FIG. 5 may be realized using polycarbonate or FR4 PCB that is light-weighted and has strong rigidity.

The frame portion 200 may further include a supporting means 22 in order to prevent the frame portion 200 from being bent due to the weight of the driving portion 300 mounted at one end thereof or being twisted due to wind or vibration of the vehicle.

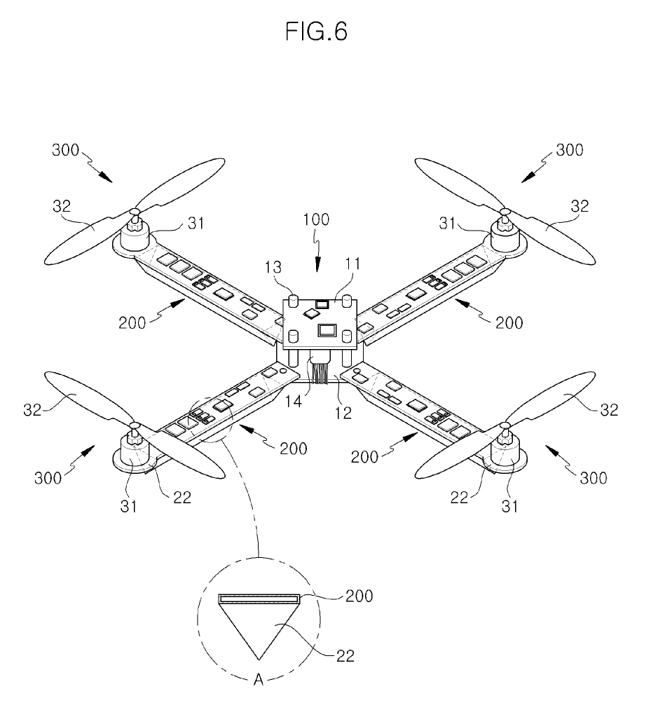

FIG. 6 exemplarily shows a structure of the unmanned flying vehicle further having a supporting means.

As shown in the example of FIG. 6, the supporting means may be realized in the shape of “∇” or “V”. In this case, the supporting means 22 formed in the shape of “∇” or “V” is mounted on the bottom side of the frame portion 200, and is preferred that a vertex of the bottom of the supporting means 22 is disposed at a center portion of the frame portion 200 in the length direction thereof so as to provide the maximum supportability to the frame portion 200.

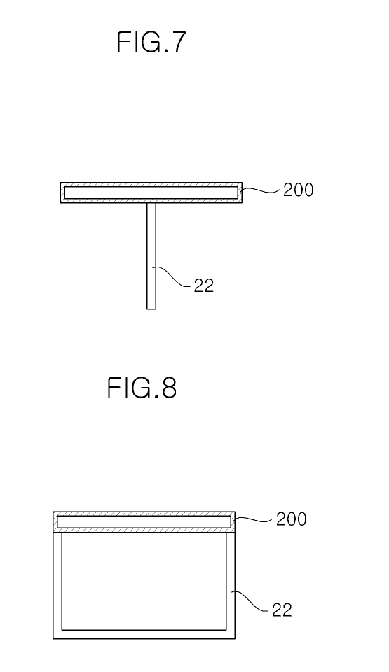

FIG. 7 and FIG. 8 respectively show other examples of the supporting means 22.

The supporting means 22 may be realized in the shape of “|” as shown in FIG. 7 and in the shape of “ [symbol] ” as shown in FIG. 8.

A supporting means 22 of FIG. 7 is mounted on the bottom side of the frame portion 200, but it is preferably disposed at a center portion of the frame portion 200 in the length direction thereof to provide the maximum supporting force, and the supporting means 22 of FIG. 8 is mounted on the bottom side of the frame portion 200, but it is preferred that both open end portions of the supporting means 22 are disposed at both ends of the frame portion 200 in the width direction thereof.

The supporting means 22 may be realized by using a light polycarbonate (PC) or FR4 PCB that can also satisfy a supporting force for supporting the frame portion 200. In addition, the supporting means 22 is not limited to the exemplary embodiments of the present invention, and may be variously modified by a person skilled in the art.

Configuration of Driving Portion 300

The driving portion 300 includes a motor 31 that changes electrical energy into mechanical energy and a propeller 32 generating an impellent force by receiving a driving force of the motor 31. An impellent force generation theory and a flying control theory are the same as those of a conventional unmanned flying vehicle.

The driving portion 300 may further include a safety propeller. A propeller safety cover 33 protects the propeller 32 from peripheral obstacles without interfering operation of the propeller 32 and simultaneously protects people around the propeller 32.

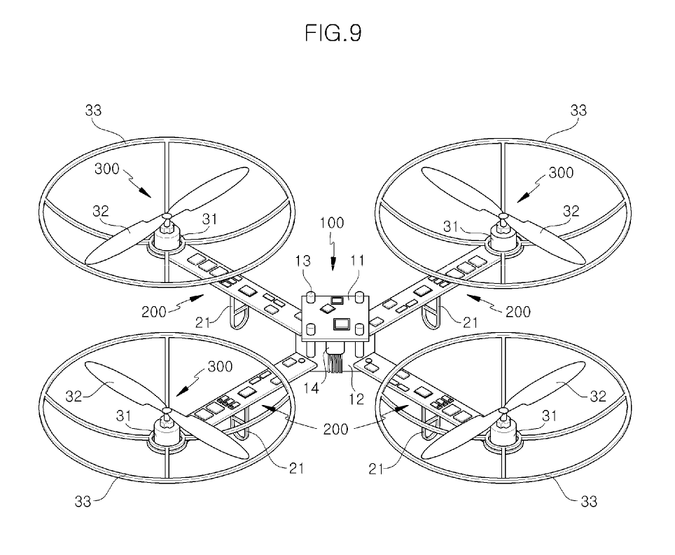

FIG. 9 exemplarily shows an unmanned flying vehicle having the safety cover mounted on the propeller. As shown in FIG. 9, the propeller safety cover 33 is formed in the shape of a semi-sphere of which an upper portion is open so that it can be fastened to the periphery of the frame portion 200 where the motor 31 is mounted. In this case, preferably, the propeller safety cover is realized with a minimum supporting frame so as not to have a large influence on the entire weight of the unmanned flying vehicle.

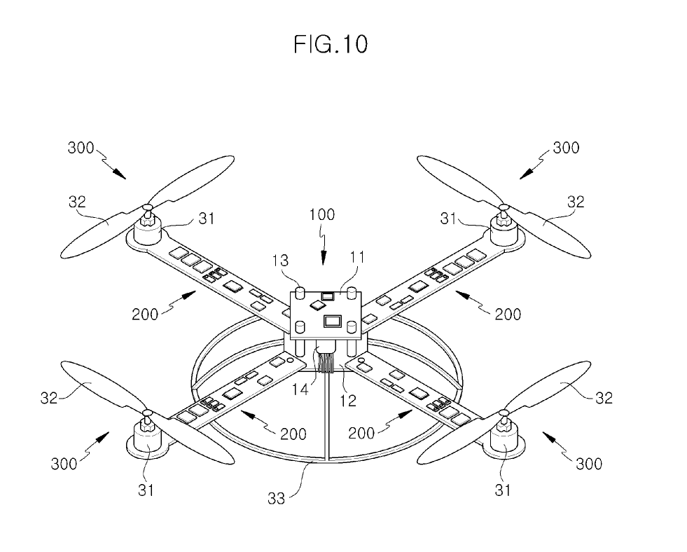

FIG. 10 shows a case that the safety cover structure of the propeller is used as a landing means of the unmanned flying vehicle.

That is, the propeller safety cover 33 is separated from the frame portion 200 and then coupled at a lower center portion of the unmanned flying vehicle as shown in FIG. 10 as necessary so that it may be used as a landing means or a landing gear.

For example, the propeller safety cover 33 is coupled to the periphery of the PCB frame where the motor is mounted because obstacles exist around the vehicle during an indoor flight, and it is coupled to the bottom side of the main board so as to be used a landing means or a landing gear because a ground side where the unmanned flying vehicle takes off or lands is covered by earth or rough asphalt during an outdoor flight.

The propeller safety cover 33 may be formed of a material that is light-weighted and strong, such as PC, carbon, or PCV, and it may be realized in the various shapes such as a ring having one supporting frame or a square pillar rather than the shape of FIG. 9.

In the above-described exemplary embodiment, at least one of a main control module, a communication module, and a sensor module is installed in the main body 100, and other modules (e.g., a sub-control module and a transmission module) are installed in the frame portion 200, but it is not restrictive, and installation locations of the modules may be variously modified by a person skilled in the art.

Particularly, a heat generating element such as an FET for power application is preferably disposed close to the propeller 32 in the frame portion 200 to cool the heat of the heat generating element with wind generated from rotation of the propeller. Thus, malfunction of the PCB and errors of the flying control due to the heat can be prevented, and accordingly the life span of the unmanned flying vehicle can be extended.

In addition, as an example of a multirotor, the quadrotor has been described with exemplary embodiments that individually provide the main body 100 and the frame portion 200, but the main body 100 and the frame portion 200 may be integrally formed in one PCB. In this case, the quadrotor is divided into a body portion (not shown) formed of one substrate formed in the shape of a square cross and a driving portion (not shown).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An unmanned flying vehicle comprising:
a body portion formed at a center thereof;
a plurality of frame portions having one end connected to the body portion and forming the entire shape of the unmanned flying vehicle; and
a plurality of driving portions mounted on the other end of the frame portion and generating an impellent force for a flight,
wherein the frame portion is formed of a print circuit board.

2. The unmanned flying vehicle of claim 1, wherein the body portion comprises a main board in the shape of PCB where at least one of a control module for flying control and a communication module for exchanging data with an external communication device is installed.

3. The unmanned flying vehicle of claim 2, wherein the body portion further comprises a battery for supplying power to the main body, the frame portion, and the driving portion.

4. The unmanned flying vehicle of claim 3, wherein the body portion comprises a plurality of main boards, the plurality of main boards are supported by a plurality of supporting shafts with a predetermined distance therebetween, and the battery is disposed in a portion of the predetermined distance.

5. The unmanned flying vehicle of claim 2, wherein a battery for supplying power to the body portion, the frame portion, and the driving portion are mounted on one side of the frame portion.

6. The unmanned flying vehicle of claim 1, wherein the frame portion comprises a transmission module for transmission of the driving portion, and the transmission module and a control module of the main board are connected through a printed circuit line.

7. The unmanned flying vehicle of claim 1, wherein the frame portion further comprises a landing means to support the flying vehicle for landing of the flying vehicle with a predetermined height from the ground.

8. The unmanned flying vehicle of claim 7, wherein the landing means is formed of one of a sponge material, a poly-styrene material, and a memory form material for buffering landing impact.

9. The unmanned flying vehicle of claim 1, wherein a support means is further mounted on the bottom side of the frame portion to prevent bending and torsion of the frame portion of the unmanned flying vehicle.

10. The unmanned flying vehicle of claim 9, wherein the supporting means is formed of at least one of polycarbonate (PC) and Frame Retardent 4(FR4).

11. The unmanned flying vehicle of claim 1, wherein an electron element having a heat generation amount that is greater than a predetermined amount is disposed at one side of the frame portion in a mounting direction of the driving portion.

12. The unmanned flying vehicle of claim 1, wherein at least one of the body portion and the frame portion is formed of a FR4 PCB.

13. The unmanned flying vehicle of claim 1, wherein the body portion and the frame portion are integrally formed with a single PCB.
